(19) United States
(12) Patent Application Publication
(10) Pub. No.: US 2012/0258609 A1
(43) Pub. Date: Oct. 11, 2012

(54) ARRANGEMENT FOR CONTROLLING A SYSTEM

(75) Inventor: Thomas WARNEKE, Hoxter (DE)

(73) Assignee: PHOENIX CONTACT GmbH & Co. KG, Blomberg (DE)

(21) Appl. No.: 13/444,311

(22) Filed: Apr. 11, 2012

(30) Foreign Application Priority Data
Apr. 11, 2011 (DE) 10 2011 961.8-34

(51) Int. Cl. H01R 29/00

(52) U.S. Cl. 439/43

(57) ABSTRACT

An arrangement for controlling a system includes a control and/or data transfer module (1) adapted to be snapped onto a mounting bar (2) and a plurality of I/O plug-in modules (3). Each I/O plug-in module (3) comprises a plurality of clip contacts (8) for connecting the system and a plurality of plug contacts (5) for plugging onto the control and/or data transfer module (1). In the plugged-on state an electrical connection is established between the I/O plug-in module (3) and the control and/or data transfer module (1). At least one I/O plug-in module comprises an electrical circuit element (11) disposed in the current path between at least one clip contact (8) and at least one plug contact (5). The arrangement for controlling a system enables adaptation of the installed automation solutions (1,3) in a highly flexible way to changes in system requirements in electrical cabinets with high packing densities.

### CROSS-REFERENCE TO RELATED APPLICATIONS

This application claims priority to Germany Patent Application serial no. DE 10 2011 001 961.8-34 filed Apr. 11, 2011, the contents of which are incorporated herein by reference in their entirety as if set forth verbatim.

### FIELD

The following description relates to an arrangement for controlling a system comprising a control and/or data transfer module adapted to be snapped onto a mounting bar and a plurality of I/O plug-in modules.

### BACKGROUND

The progressive miniaturization of automation solutions for controlling systems enables more and more increasing packing densities in electrical cabinets such that during the installation of such an automation solution in an electrical cabinet the number of input/output points for connecting sensors and actuators, respectively, for controlling the system per meter width of the switchboard can be increased. Moreover in some implementations according to the specific application further circuit elements such as noise filters, overvoltage protection elements and/or measurement or terminal resistances are required which often are offered as accessories to be installed additionally for mounting onto a mounting bar in the electrical cabinet.

However, the abovementioned circuit elements are generally not integrated within the automation solutions ex factory in order to keep the frame size of the above-mentioned devices as small and compact as possible and thus require additional installation space on the mounting bar as well as expensive wiring and/or documentation effort specifically adapted to the circuit elements. Often only after finishing the complete wiring of the electrical cabinet is it recognized, for example during the pilot stage of a system, that an additional circuitry using the abovementioned circuit elements is required. However, when due to the high packing density there is no more free installation space on the mounting bar, the electrical cabinet has to be reconstructed in order to be able to install the additional circuit elements which is accompanied with a considerable amount of time and/or money.

Accordingly, there is a need for an arrangement for controlling a system which can be configured particularly flexibly in terms of possible additional circuit elements. The embodiments disclosed below satisfy this and other needs.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

Thus, the object of the invention is achieved, in one embodiment, by an arrangement for controlling a system comprising a control and/or data transfer module adapted to be snapped onto a mounting bar and a plurality of I/O plug-in modules, wherein each I/O plug-in module comprises a plurality of clip contacts for connecting the system, each I/O plug-in module comprises a plurality of plug contacts for plugging onto the control and/or data transfer module such that in the plugged-on state an electrical connection between the I/O plug-in module and the control and/or data transfer module is established and at least one I/O module comprises an electrical circuit element and the electrical circuit element is arranged in a current path between at least one clip contact and at least one plug contact.

Thus, in the presently disclosed embodiments, and unlike in known devices, additional circuit elements are not arranged separately from the arrangement and the control and/or data transfer module and/or the I/O plug-in module, respectively, for example on an additional mounting bar, but rather are arranged in and/or on the input/output (I/O) plug-in module. Thus, in a particularly easy way a circuit element can be arranged later at an I/O plug-in module, i.e. for example after the control and/or data transfer module and the I/O plug-in modules have been arranged on a mounting bar in an electrical cabinet, or alternatively or additionally an I/O plug-in module can be replaced by another I/O module which comprises the circuit element required for the system. By means of the inventive arrangement particularly in electrical cabinets having high packing densities it is enabled to adapt the installed automation solutions highly flexibly to changes of system requirements, for example, at so-called “last minute” changes in the pilot stage of the system without requiring additional installation space on the mounting bar and without the need for changing the wiring of the automation solutions comprising the control and/or data transfer module as well as the I/O plug-in modules in an expensive way or to reconfigure the electrical cabinet to this end. Moreover the inventive arrangement still enables the manufacture of the I/O plug-in modules in a particularly inexpensive way because not all circuit elements which are possibly required have to be already integrated “in stock” in the I/O plug-in module during its manufacture and thus the I/O plug-in module can be manufactured, as before, in an unchanged size, however, if required, additionally necessary circuit elements can be arranged in and/or on an I/O plug-in module in a particularly flexible and easy way. Furthermore in the presently disclosed embodiments it is preferred that all I/O plug-in modules of the inventive arrangement each comprise an electrical circuit element.

Because the electrical circuit element is arranged in the current path between a clip contact and a plug contact, i.e. between the system and the control and/or data transfer module, by means of the electrical circuit elements input signals and/or output signals can be influenced directly by the electrical circuit element. Thus, the presently disclosed embodiments enable, for example, that a 24 Volt output provided by the control and/or data transfer module or the I/O plug-in module is capable to provide a voltage in the range of 60 to 230 Volt by an electrical circuit element which is implemented as a coupling relay without the need for replacing the control and/or data transfer module.

The control and/or data transfer module is preferable configured such that on the one side interfaces for electrical connection with the I/O plug-in modules are provided and on the other side in addition to a control means for controlling the system communication and/or interface connections for connecting the control and/or data transfer module with further control and/or data transfer modules are provided. Moreover the control and/or data transfer module can be configured such that in addition to the abovementioned communication and/or interface connections for data transfer a bus terminal is provided in place of a control means, wherein the I/O plug-in modules can be plugged on the bus terminal. Such a bus terminal can be implemented as an arbitrary bus terminal known in the art. Moreover, in place of clip contacts and/or plug contacts arbitrary contacting means on the one side for connecting the modules of the inventive arrangement with each other and on the other side for connecting the I/O plug-in modules with the system can be provided.

Basically the electrical circuit element can be configured arbitrarily. In a preferred embodiment the electrical circuit element is implemented as a passive and/or as an active electrical device, in particular as a resistor, a filter choke, a capacitor, a semiconductor circuit, a DC/DC voltage converter, a signal separator, a line driver and/or a relay. Moreover the electrical circuit element can also comprise a circuit board and/or a heat sink. According to this preferred arrangements of the invention an “appropriate” electrical circuit element can be selected application-specific and subsequently arranged in the I/O plug-in module and/or an I/O plug-in module including such an “appropriate” circuit element can be snapped onto the control and/or data transfer module. In this regard it is particularly preferred that the electrical circuit element comprises a safety relay including a signaling contact and the signaling contact is connected with the plug contacts. Thus, in a particularly easy way safety relevant applications can be realized by the I/O plug-in module without the need for a complex additional circuitry in the electrical cabinet which would require additional installation space on a mounting bar.

According to a further preferred embodiment it is provided that the I/O plug-in module comprises a housing and the electrical circuit element is disposed within the housing and/or can be plugged onto a clip contact arranged at the housing from outside of the housing. Thus, according to this embodiment, too, it is possible that the electrical circuit element can not only be preassembled within the housing but can also later be plugged onto the housing of the I/O plug-in module, i.e. when the inventive arrangement, for example, is already mounted within an electrical cabinet, such that a functionality necessary for the system and possibly determined after the installation of the inventive arrangement can be realized in a particularly space-saving way by simply plugging on the electrical circuit element onto the housing or onto a clip contact of the I/O plug-in module arranged at the housing.

According to another embodiment in this context it is preferred that the electrical circuit element can be plugged on a clip contact provided at the housing from the outside of the housing and the I/O plug-in module is configured such that the system alternatively can be connected to the I/O plug-in module through a clip contact and an electrical circuit element can be connected to the I/O plug-in module by being plugged onto the clip contact. This means that according to this embodiment it is provided that an I/O module is capable of performing two functions, i.e. on the one hand it enables the connection of an actuator and/or sensors of the system and on the other hand it enables that an electrical circuit element to be plugged onto the same clip contact. Thus it is provided that the I/O module can be wired in different ways without the need for changing the configuration of the I/O plug-in module.

In this context it is further preferred that the electrical circuit element can be plugged on a clip contact which is provided at the housing from outside of the housing, and the I/O plug-in module is configured such that the system can be connected to the I/O plug-in module through a first part of the clip contacts and an electrical circuit element can be connected to the I/O plug-in module through a second part of the clip contacts by being plugged on. Thus, it is preferred that a part of the clip contacts can be connected to the system while another part of the clip contacts is configured such that the circuit element can be plugged onto the clip contacts. In this context it is further preferred that the second part of the clip contacts is arranged at a distance from the first part of the clip contacts. To this end the I/O plug-in module preferably comprises a plug-in field in which the second part of the clip contacts is arranged such that in a particular easy way and separately from cables which, for example, lead from the first part of the clip contacts to the system an electrical circuit element can be plugged onto this separate plug-in field. To this end the above-mentioned plug-in field can be arranged at an end of the I/O plug-in module or between a group of clip contacts on the I/O plug-in module.

Basically the control and/or data transfer module can be programmable and/or configurable in any way known in the art. However, according to a further preferred embodiment of the invention it is preferred that the control and data transfer module is configurable according to the I/O plug-in modules which can be plugged on and the I/O plug-in modules are configured such that if a first I/O plug-in module is removed from the control and/or data transfer module and subsequently a second I/O plug-in module is plugged onto the control and/or data transfer module it is not necessary to change the configuration of the control and/or data transfer module. According to this configuration it is also provided that an I/O plug-in module can be replaced by another I/O plug-in module which compared to the first I/O plug-in module preferably comprises a different electrical circuit element without the need for reconfiguring the control and/or data transfer module. This means that, for example, in the pilot stage of a system an I/O plug-in module comprising another circuit element can be plugged onto the control and/or data transfer module without the need for changing the configuration of the control and/or data transfer module.

Basically the control and/or data transfer module can comprise a certain number of I/O plug-in modules, such as 2, 4 or 8 I/O plug-in modules, each comprising inputs and/or outputs for connecting sensors and actuators, respectively, of the system. However, according to a further preferred embodiment it is provided that the arrangement comprises an expansion module, wherein the expansion module can be connected to the control and/or data transfer module such that in the connected state an electrical connection between the expansion module and the control and/or data transfer module is established and the expansion module is configured such that an I/O plug-in module can be snapped onto the expansion module and in the snapped on state an electrical connection between the I/O plug-in module and the expansion module is established. Preferably the expansion module is configured such that a second expansion module can be connected with the above-mentioned first expansion module such that in the connected state of both expansion modules an electrical connection is established between both expansion modules. According to this embodiment the arrangement can be expanded by any number of I/O plug-in modules for connecting sensors and/or actuators to a system such that the arrangement can be applied in a particularly flexible way for controlling systems of different sizes. Moreover it is preferred that the width of the I/O plug-in module corresponds to the width of the expansion module. Moreover an expansion module can be configured such that 2, 4, 6 or 8 I/O plug-in modules can be plugged onto the expansion module. With this kind of an expansion module the arrangement can be modularly expanded with any number of I/O modules and thus can be applied particularly flexibly.

Basically the size of the housing of the I/O plug-in module can be chosen arbitrarily. According to a particularly preferred embodiment of the invention, however, it is provided that the I/O plug-in module, i.e. preferably the housing of the I/O plug-in module, has a width of 12 mm and a height of 18 mm in the area in which the I/O plug-in module in the plugged-in state abuts against the control and/or data transfer module. With such a dimensioning it becomes possible to achieve a very high packing density in an electrical cabinet such that a particularly large number of I/O points per meter width of the electrical cabinet can be realized, i.e. in a very small space a very large number of inputs and/or outputs for controlling the system can be provided.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 shows an exploded view of an arrangement comprising a control and/or data transfer module, a plurality of I/O plug-in modules and expansion modules according to a preferred embodiment of the invention;

FIG. 2 shows a cross sectional view of the control and/or data transfer module comprising an I/O plug-in module according to the preferred embodiment of the invention; and

FIGS. 3a-c show perspective views of three I/O plug-in modules according to different preferred embodiments of the invention.

### DETAILED DESCRIPTION

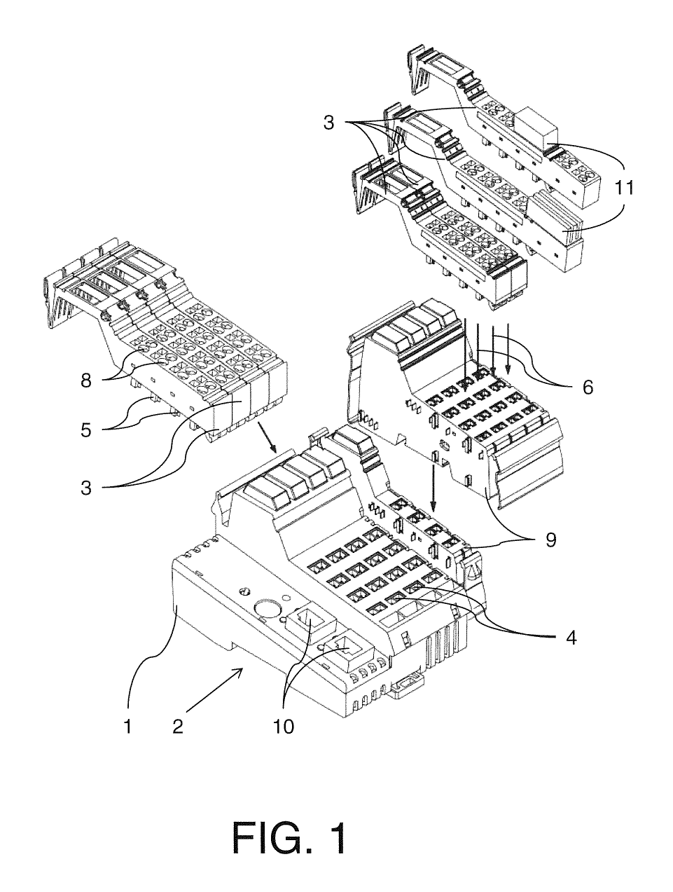

In one aspect of the disclosed embodiments, FIG. 1 shows an inventive arrangement for controlling a system comprising a control and/or data transfer module 1 adapted to be snapped onto a mounting bar 2 (not shown) and comprising a plurality of I/O plug-in modules 3.

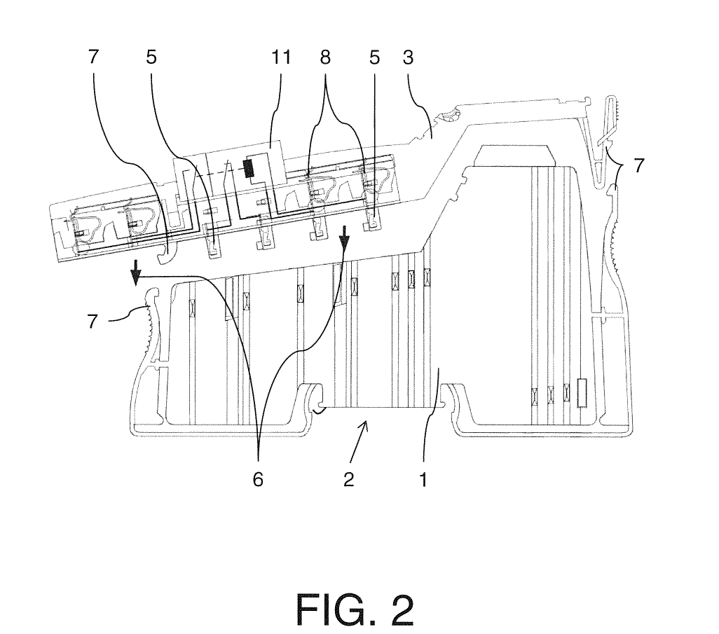

The control and/or data transfer module 1 comprises a plurality of contacts 4 which, when an I/O plug-in module 3 is snapped onto the control and/or data transfer module 1, establish an electrical connection with clip contacts 5 provided at the I/O plug-in module 3. Said snap-on operation is indicated by an arrow 6 in FIG. 1 and FIG. 2 which is a cross sectional view of the control and/or data transfer module 1 and the I/O plug-in module 3. To this end both the control and/or data transfer module 1 and the I/O plug-in module 3 comprise snap-in means 7 which are provided at both ends of the I/O plug-in module 3 and enable unlocking the I/O plug-in module 3 from the control and/or data transfer module 1 by means of a lever. In the engaged state the I/O plug-in module rests directly on the control and/or data transfer module 1 in the area of the plug contacts 5.

For connecting sensors and/or actuators of the system the I/O plug-in module comprises 3 clip contacts 8. While, as shown in FIG. 1, four I/O plug-in modules 3 can be snapped onto the control and/or data transfer module 1 expansion modules 9 can be connected to the control and/or data transfer module 1 such that in the connected state an electrical connection between the expansion module 9 and the control and/or data transfer module 1 can be established. The expansion module 9 is configured such that an I/O expansion module 3 can be snapped onto the expansion module 9 as well. Moreover, as shown in FIG. 1, expansion modules 9 can be configured such that only a single I/O expansion module 3 can be plugged on the expansion module 9 or four I/O expansion modules 3 can be plugged on a second arrangement of the expansion module 9.

The control and/or data transfer module 1 further comprises communication interfaces 10 adapted to be connected to further control and/or data transfer modules 1 as well as a microprocessor (not shown) for controlling the system.

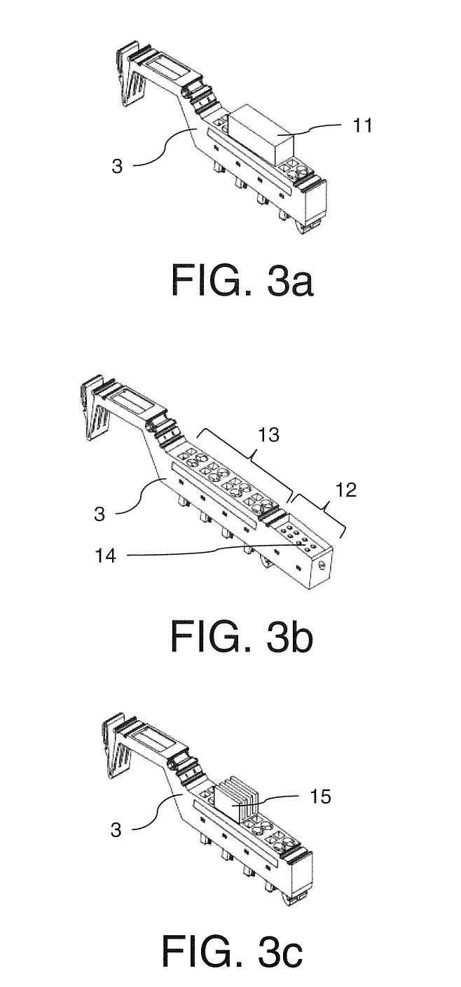

According to various embodiments it is provided that at least one I/O plug-in module 3 comprises an electrical circuit element 11 which is disposed in the current path between a clip contact 8 and a plug contact 5. The electrical circuit element 11, as shown in FIG. 1 or FIG. 3a, can be snapped onto the I/O plug-in module 3, for example, be snapped into the clip contacts 8, or, as shown in FIG. 2, be disposed within the housing of the I/O plug-in module 3.

Herein the electrical circuit element 11 basically can be configured as any passive and/or active electrical device such as a resistor, a filter choke, a capacitor, a semiconductor circuit, a DC/DC voltage converter, a signal separator, a line driver and/or a relay, as shown in FIG. 2. Moreover the electrical circuit element 11 can be configured as a safety relay for implementing a safety relevant circuit, wherein the safety relay can comprise a signaling contact which can be connected to the plug contacts 5, too.

Moreover it is possible, as shown in FIG. 3b, that, when the electrical circuit element 11 is provided within the I/O plug-in module 3, a second part 12 of the clip contacts 8 is disposed in a distance from a first part 13 of the clip contacts 8 such that an electrical circuit element 11 can be plugged onto such a plug-in field 14. Moreover it is possible to provide a heat sink 15 which can be snapped onto the clip contacts 8 such that heat produced by the electrical circuit element 1 can be dissipated by the heat sink 15, as shown in FIG. 1 or FIG. 3c.

Because of the fact that the circuit element 11 is disposed in or at the I/O plug-in module 3 even after the inventive arrangement has already been installed in an electrical cabinet additional circuitries can be realized in a particularly easy way by plugging on an electrical circuit element 11 which is required for the additional circuitry onto the I/O plug-in module, as shown in FIG. 3a. Thus, for example, insofar as the I/O plug-in module 3 only has 24 Volt inputs, high voltage inputs can be realized in a particularly easy way by a circuit element 11 which is implemented as an opto-coupler circuit without the need for replacing the entire arrangement in the electrical cabinet.

Moreover all or a part of the clip contacts 8 can be implemented such that optionally a sensor and/or an actuator of the system can be connected to the clip contact 8 or an electrical circuit element 11 can be snapped onto the clip contact 8. Moreover, because the housing of the I/O plug-in module 3 in the region of the plug contacts 5 has a width of only 12 mm and a height of 18 mm, the arrangement enables a particularly space-saving installation in an electrical cabinet and thus to achieve a high packing density with a large number of I/O terminals per meter width of the electrical cabinet which, however, is configurable extremely flexible with respect to different system circuitries.

### LIST OF REFERENCE SYMBOLS

1 Control and/or data transfer module
2 Mounting bar
3 I/O plug-in module
4 Contacts
5 Plug contact
6 Arrow
7 Snap-in means
8 Clip contact
9 Expansion module
10 Communication interface
11 Circuit element
12 Second part
13 First part
14 Plug-in field
15 Heat sink

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An arrangement for controlling a system, comprising a control and/or data transfer module (1) adapted to be snapped onto a mounting bar (2) and a plurality of I/O plug-in modules (3), wherein
each I/O plug-in module (3) comprises a plurality of clip contacts (8) for connecting the system;
each I/O plug-in module (3) comprises a plurality of plug contacts (5) for plugging onto the control and/or data transfer module (1) such that in the plugged-on state an electrical connection is established between the I/O plug-in module (3) and the control and/or data transfer module (1); and
at least one I/O plug-in module (3) comprises an electrical circuit element (11), wherein the electrical circuit element (11) is disposed in the current path between at least one clip contact (8) and at least one plug contact (5).

2. The arrangement for controlling a system of claim 1, wherein the electrical circuit element (11) is a passive and/or an active electrical device, in particular, a resistor, a filter choke, a capacitor, a semiconductor circuit, a DC/DC voltage converter, a signal separator, a line driver and/or a relay.

3. The arrangement for controlling a system of claim 1, wherein the electrical circuit element (11) is a safety relay including a signaling contact and the signaling contact is connected with the plug contacts (5).

4. The arrangement for controlling a system of claim 1, wherein the I/O plug-in module (3) comprises a housing and the electrical circuit element (11) is disposed within the housing and/or can be plugged onto a clip contact (8) arranged at the housing from outside of the housing.

5. The arrangement for controlling a system of claim 4, wherein the electrical circuit element (11) can be plugged onto a clip contact (8) which is provided at the housing from outside of the housing and the I/O plug-in module (3) is configured such that the system alternatively can be connected to the I/O plug-in module (3) through a clip contact (8) and an electrical circuit element (11) can be connected to the I/O plug-in module (3) by plugging onto the clip contact (8).

6. The arrangement for controlling a system of claim 4, wherein the electrical circuit element (11) can be plugged onto a clip contact (8) which is provided at the housing from outside of the housing and the I/O plug-in module (3) is configured such that the system can be connected to the I/O plug-in module (3) through a first part of the clip contacts (8) and an electrical circuit element (11) can be connected to the I/O plug-in module (3) by plugging onto a second part (12) of the clip contacts (8).

7. The arrangement for controlling a system of claim 6, wherein the second part (12) of the clip contacts (8) is disposed distant from the first part 13) of the clip contacts (8).

8. The arrangement for controlling a system of claim 1, wherein the control and/or data transfer module (1) is configurable in terms of the pluggable I/O plug-in modules (3) and the I/O plug-in modules (3) are configured such that, when a first I/O plug-in module (3) is removed from the control and/or data transfer module (1) and a second I/O plug-in module (3) is plugged onto the control and/or data transfer module (1), it is not necessary to change the configuration of the control and/or data transfer module (1).

9. The arrangement for controlling a system of claim 1, comprising an expansion module (9), wherein the expansion module (9) can be connected to the control and/or data transfer module (1) such that in the connected state an electrical connection is established between the expansion module (9) and the control and/or data transfer module (1) and the expansion module (9) is configured such that an I/O plug-in module (3) can be snapped onto the expansion module (9) and in the snapped-on state an electrical connection between the I/O plug-in module (3) and the expansion module (9) is established.

10. The arrangement for controlling a system of claim 1, wherein the I/O plug-in module (3) has a width of 12 mm and a height of 18 mm in the area in which the I/O plug-in module (3) in the plugged-in state abuts against the control and/or data transfer module (1).
